(19) United States
(12) Patent Application Publication
(10) Pub. No.: US 2026/0046716 A1
(43) Pub. Date: Feb. 12, 2026

(54) TIME DIVISION DUPLEXING PATTERN INDICATION FOR LAYER 1 OR LAYER 2 TRIGGERED MOBILITY

(71) Applicant: Qualcomm Incorporated, San Diego, CA (US)

(72) Inventors: Wooseok NAM, San Diego, CA (US); Ruhua HE, San Diego, CA (US); Jelena DAMNJANOVIC, Del Mar, CA (US); Mona AGRAWAL, San Diego, CA (US); Rong YANG, Kanata (CA)

(21) Appl. No.: 19/291,344

(22) Filed: Aug. 5, 2025

Related U.S. Application Data
(60) Provisional application No. 63/680,466, filed on Aug. 7, 2024.

(51) Int. Cl. H04W 36/04; H04L 5/14; H04W 74/0833; H04W 76/20

(52) U.S. Cl. CPC H04W 36/04; H04L 5/1469; H04W 74/0833; H04W 76/20

(57) ABSTRACT

Various aspects of the present disclosure generally relate to wireless communication. In some aspects, a user equipment (UE) may receive a Layer 1 or Layer 2 (L1/L2) triggered mobility (LTM) configuration that indicates a time division duplexing (TDD) pattern associated with an LTM candidate cell. The UE may identify, in accordance with an early uplink synchronization with the LTM candidate cell, one or more valid random access channel (RACH) occasions (ROs) in the LTM candidate cell in accordance with the TDD pattern associated with the LTM candidate cell. Numerous other aspects are described.

### CROSS-REFERENCE TO RELATED APPLICATION

This Patent Application claims priority to U.S. Provisional Patent Application No. 63/680,466, filed on Aug. 7, 2024, entitled “TIME DIVISION DUPLEXING PATTERN INDICATION FOR LAYER 1 OR LAYER 2 TRIGGERED MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with a time division duplexing pattern indication for Layer 1 or Layer 2 triggered mobility.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a user equipment (UE) for wireless communication. The UE may include one or more memories and one or more processors coupled to the one or more memories. The one or more processors may be configured to receive a Layer 1 or Layer 2 (L1/L2) triggered mobility (LTM) configuration that indicates a time division duplexing (TDD) pattern associated with an LTM candidate cell. The one or more processors may be configured to identify, in accordance with an early uplink synchronization with the LTM candidate cell, one or more valid random access channel (RACH) occasions (ROs) in the LTM candidate cell in accordance with the TDD pattern associated with the LTM candidate cell.

Some aspects described herein relate to a method of wireless communication performed by a UE. The method may include receiving an LTM configuration that indicates a TDD pattern associated with an LTM candidate cell. The method may include identifying, in accordance with an early uplink synchronization with the LTM candidate cell, one or more valid ROs in the LTM candidate cell in accordance with the TDD pattern associated with the LTM candidate cell.

Some aspects described herein relate to a non-transitory computer-readable medium that stores a set of instructions for wireless communication by a UE. The set of instructions, when executed by one or more processors of the UE, may cause the UE to receive an LTM configuration that indicates a TDD pattern associated with an LTM candidate cell. The set of instructions, when executed by one or more processors of the UE, may cause the UE to identify, in accordance with an early uplink synchronization with the LTM candidate cell, one or more valid ROs in the LTM candidate cell in accordance with the TDD pattern associated with the LTM candidate cell.

Some aspects described herein relate to an apparatus for wireless communication. The apparatus may include means for receiving an LTM configuration that indicates a TDD pattern associated with an LTM candidate cell. The apparatus may include means for identifying, in accordance with an early uplink synchronization with the LTM candidate cell, one or more valid ROs in the LTM candidate cell in accordance with the TDD pattern associated with the LTM candidate cell.

Some aspects described herein relate to a serving network node for wireless communication. The serving network node may include one or more memories and one or more processors coupled to the one or more memories. The one or more processors may be configured to receive, from an LTM candidate cell, a TDD pattern associated with the LTM candidate cell. The one or more processors may be configured to transmit, to a UE, an LTM configuration that indicates the TDD pattern associated with the LTM candidate cell.

Some aspects described herein relate to a method of wireless communication performed by a serving network node. The method may include receiving, from an LTM candidate cell, a TDD pattern associated with the LTM candidate cell. The method may include transmitting, to a UE, an LTM configuration that indicates the TDD pattern associated with the LTM candidate cell.

Some aspects described herein relate to a non-transitory computer-readable medium that stores a set of instructions for wireless communication by a serving network node. The set of instructions, when executed by one or more processors of the serving network node, may cause the serving network node to receive, from an LTM candidate cell, a TDD pattern associated with the LTM candidate cell. The set of instructions, when executed by one or more processors of the serving network node, may cause the serving network node to transmit, to a UE, an LTM configuration that indicates the TDD pattern associated with the LTM candidate cell.

Some aspects described herein relate to an apparatus for wireless communication. The apparatus may include means for receiving, from an LTM candidate cell, a TDD pattern associated with the LTM candidate cell. The apparatus may include means for transmitting, to a UE, an LTM configuration that indicates the TDD pattern associated with the LTM candidate cell.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network.

FIG. 2 is a diagram illustrating an example network node in communication with a user equipment (UE) in a wireless network.

FIG. 3 is a diagram illustrating an example disaggregated base station architecture.

FIGS. 4 and 5 are diagrams illustrating examples of Layer 1 or Layer 2 triggered mobility (LTM).

FIG. 6 is a diagram illustrating an example of an LTM procedure.

FIG. 7 is a diagram illustrating examples of mapping valid random access channel (RACH) occasions (ROs).

FIG. 8 is a diagram illustrating an example of mapping valid ROs in accordance with a time division duplexing (TDD) pattern.

FIG. 9 is a diagram illustrating an example associated with associated with a TDD pattern indication for LTM.

FIG. 10 is a flowchart illustrating an example process performed, for example, by a UE.

FIG. 11 is a flowchart illustrating an example process performed, for example, by a network node.

FIGS. 12 and 13 are diagrams of example apparatuses for wireless communication.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

In a wireless network, a user equipment (UE) and a network node may communicate on an access link using directional links (e.g., using high-dimensional phased arrays) to benefit from a beamforming gain and/or to maintain acceptable communication quality. The directional links, however, typically require fine alignment of transmit and receive beams, which may be achieved through a set of operations referred to as beam management and/or beam selection, among other examples. Further, a wireless network may support multi-beam operation at relatively high carrier frequencies that may be associated with harsher propagation conditions than comparatively lower carrier frequencies. For example, relative to a sub-6 gigahertz (GHz) band (e.g., FR1), signals propagating in a millimeter wave frequency band (e.g., within FR2 or FR4) may suffer from increased pathloss and severe channel intermittency, and/or may be blocked by objects commonly present in an environment surrounding the UE (e.g., buildings, trees, and/or a body of a user, among other examples). Accordingly, beam management is particularly important for multi-beam operation in a relatively high carrier frequency.

To enhance multi-beam operation at higher carrier frequencies, a wireless network may support efficient (e.g., low latency and/or low overhead) downlink and/or uplink beam management operations to support Layer 1 or Layer 2 (L1/L2)-centric inter-cell mobility. For example, L1/L2 signaling may be referred to as “lower-layer” signaling and may be used to activate and/or deactivate candidate cells in a set of cells configured for L1/L2 triggered mobility (LTM), which may be interchangeably referred to as lower-layer triggered mobility, and/or to provide reference signals for measurement by a UE (e.g., such that the UE may select a candidate beam as a target beam for an L1/L2 handover operation). Accordingly, one goal or principle underlying LTM is to enable a UE to perform a cell switch via dynamic control signaling at lower layers (for example, downlink control information (DCI) for L1 signaling or a medium access control (MAC) control element (MAC-CE) for L2 signaling), rather than semi-static Layer 3 (L3) radio resource control (RRC) signaling, in order to reduce latency, reduce overhead, reduce complexity and/or processing burdens on a UE, and/or otherwise increase efficiency of the cell switch.

For example, a UE may receive a MAC-CE that carries an LTM cell switch command, which may allow the UE to switch to a configured LTM target cell without having to perform a random access channel (RACH) procedure in the LTM target cell in cases where the LTM cell switch command includes a valid timing advance command, or when a measured timing advance associated with the LTM target cell is available. For example, in some cases, a network node may provide an LTM candidate cell configuration to a UE, and the LTM candidate cell configuration may indicate physical RACH (PRACH) transmission parameters that the UE can use to acquire a valid timing advance or timing adjustment from an LTM candidate cell before an LTM cell switch. For example, a serving network node may transmit a physical downlink control channel (PDCCH) order to the UE to trigger a PRACH transmission in an LTM candidate cell, and the UE may use the PRACH transmission parameters in the early uplink synchronization configuration to transmit a PRACH to acquire the timing advance. In this way, by providing the early uplink synchronization separately from a full RRC configuration message associated with the LTM candidate cell, the UE can obtain the PRACH configuration associated with the LTM candidate cell without having to parse or otherwise process the full RRC configuration message associated with the LTM candidate cell (e.g., the UE may parse the full RRC configuration message associated with the LTM candidate cell only after receiving the LTM cell switch command).

However, when the UE receives the PDCCH order triggering the PRACH transmission in the LTM candidate cell, the UE can only transmit the PRACH in a valid RACH occasion (RO). For example, an RO is generally considered valid when the RO does not precede a synchronization signal block (SSB) in a PRACH slot and starts at least a threshold number of symbols after a last SSB symbol. Alternatively, in cases where the UE is configured with a parameter that indicates a time division duplexing (TDD) pattern, an RO is considered valid when the RO is within uplink symbols. Accordingly, in order to identify a valid RO in which to transmit the PRACH in the LTM candidate cell, the UE may need to obtain a TDD pattern associated with the LTM candidate cell in order to identify an SSB-to-RO mapping in the LTM candidate cell. However, as described herein, an LTM configuration indicates an early uplink synchronization for an LTM candidate cell and separately indicates a full RRC configuration message that includes the TDD pattern for the LTM candidate cell. Accordingly, to identify a valid RO in which to transmit a PRACH in the LTM candidate cell, the UE has to obtain the TDD pattern for the LTM candidate cell either by acquiring and decoding system information that the LTM candidate cell broadcasts or by parsing the full RRC configuration message associated with the LTM candidate cell before receiving an LTM cell switch command, which essentially negates the purpose of separately providing the early uplink synchronization configuration and the full RRC configuration message associated with the LTM candidate cell.

Various aspects described herein generally relate to indicating a TDD pattern associated with an LTM candidate cell within an LTM configuration associated with LTM candidate cell. More particularly, as described herein, the TDD pattern associated with the LTM candidate cell is indicated separately from the full RRC configuration message associated with the LTM candidate cell. For example, in some aspects, a serving network node may obtain the TDD pattern associated with the LTM candidate cell and provide the LTM configuration indicating the TDD pattern associated with the LTM candidate cell to the UE the during an LTM preparation stage. In some aspects, the LTM configuration may indicate the TDD pattern associated with the LTM candidate cell and the early uplink synchronization configuration associated with the LTM candidate cell at the same hierarchical level, or the LTM configuration may indicate the TDD pattern as a parameter within the early uplink synchronization configuration associated with the LTM candidate cell. Accordingly, when the UE receives a PDCCH order or another suitable event triggers a PRACH transmission in the LTM candidate cell, the UE may identify a valid RO according to the indicated TDD pattern and may transmit a PRACH in the valid RO to acquire a valid timing advance for the LTM candidate cell before receiving an LTM cell switch command.

Particular aspects of the subject matter described in this disclosure can be implemented to realize one or more of the following potential advantages. In some examples, by indicating the TDD pattern associated with an LTM candidate cell separately from a full RRC configuration message associated with the LTM candidate cell, the described techniques can enable a UE to identify a valid RO in the LTM candidate cell without having to parse a full RRC configuration message associated with the LTM candidate cell or decode system information broadcast by the LTM candidate cell. In this way, some aspects described herein may reduce a processing burden on the UE when performing early uplink synchronization in the LTM candidate cell, and may enable the UE to conserve resources by parsing the RRC configuration message associated with the LTM candidate cell only when a cell switch command is received triggering an LTM handover to the LTM candidate cell.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

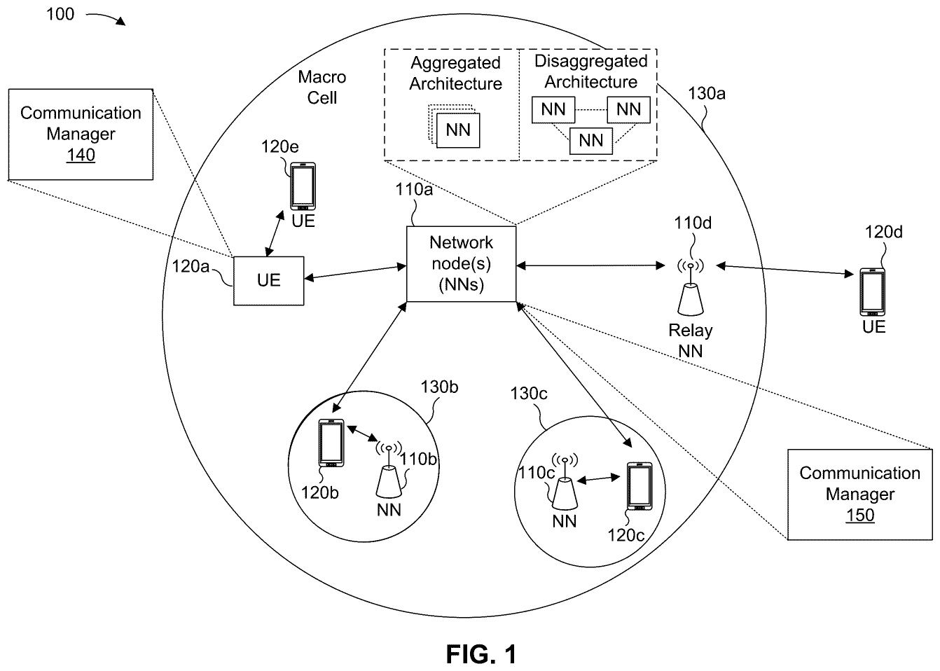

FIG. 1 is a diagram illustrating an example of a wireless communication network 100. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as RRC functions, packet data convergence protocol (PDCP) functions, and/or service data adaptation protocol (SDAP) functions, among other examples. A DU may host one or more of a radio link control (RLC) layer, a MAC layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic arca and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve TDD, in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an LTM configuration that indicates a TDD pattern associated with an LTM candidate cell; and perform early uplink synchronization with the LTM candidate cell, wherein performing the early uplink synchronization includes identifying one or more valid ROs in the LTM candidate cell in accordance with the TDD pattern associated with the LTM candidate cell (e.g., the UE 120 may identify the one or more valid ROs in accordance with an early uplink synchronization with the LTM candidate cell). Additionally, or alternatively, the communication manager 140 may perform one or more other operations described herein.

In some aspects, the network node 110 may include a communication manager 150. As described in more detail elsewhere herein, the communication manager 150 may receive, from an LTM candidate cell, a TDD pattern associated with the LTM candidate cell; and transmit, to a UE 120, an LTM configuration that indicates the TDD pattern associated with the LTM candidate cell. Additionally, or alternatively, the communication manager 150 may perform one or more other operations described herein.

As indicated above, FIG. 1 is provided as an example. Other examples may differ from what is described with regard to FIG. 1.

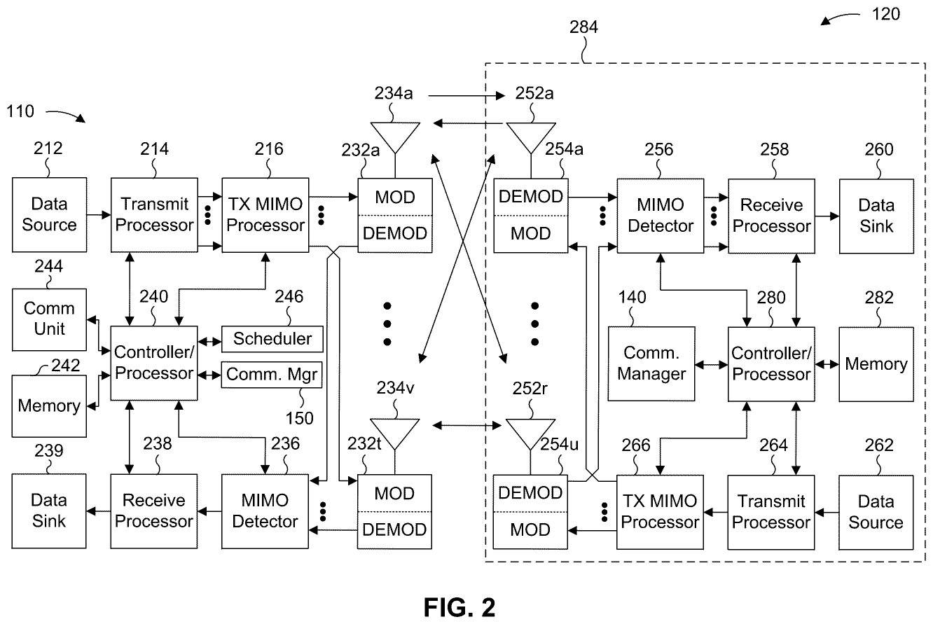

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more modulation and coding schemes (MCSs) for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC-CE communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

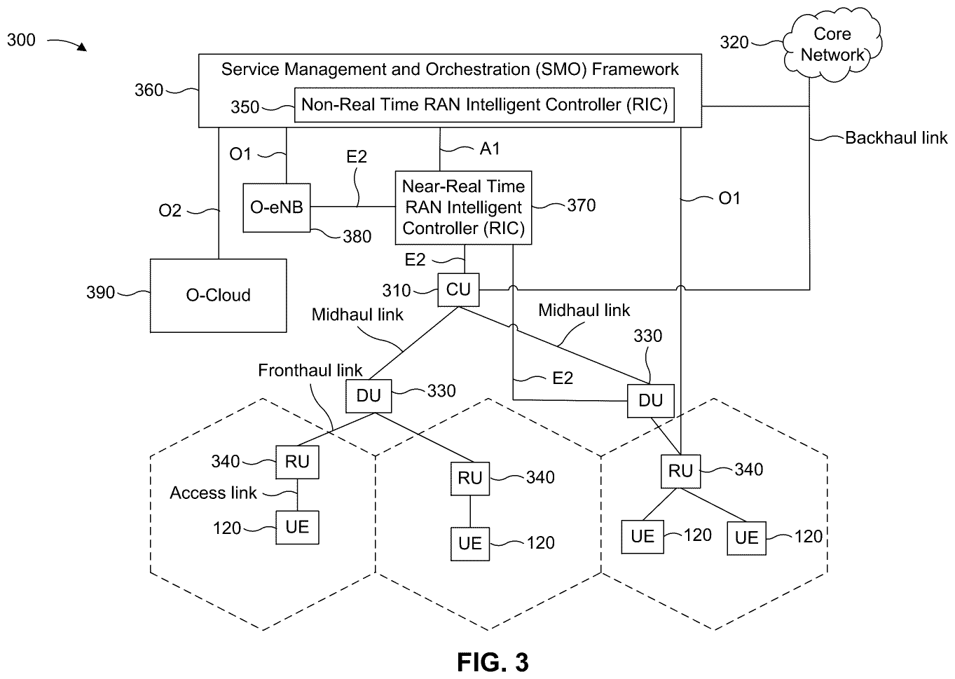

FIG. 3 is a diagram illustrating an example disaggregated base station architecture 300. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the El interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

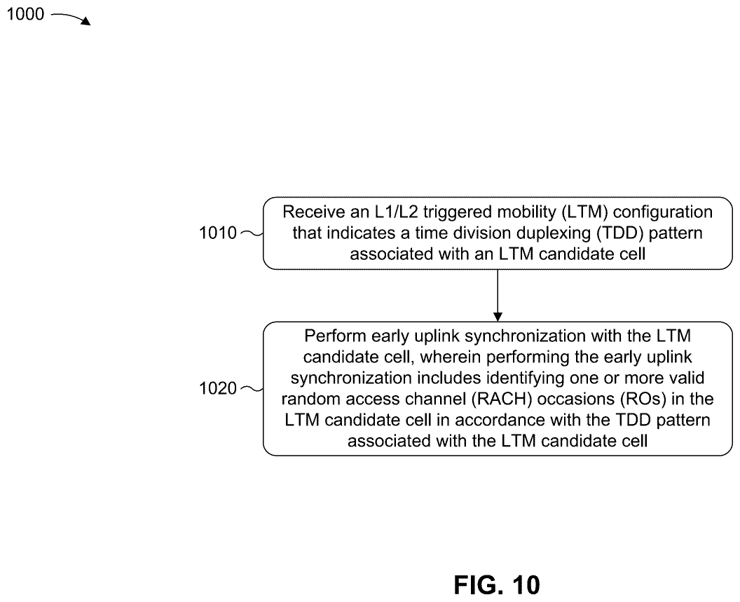

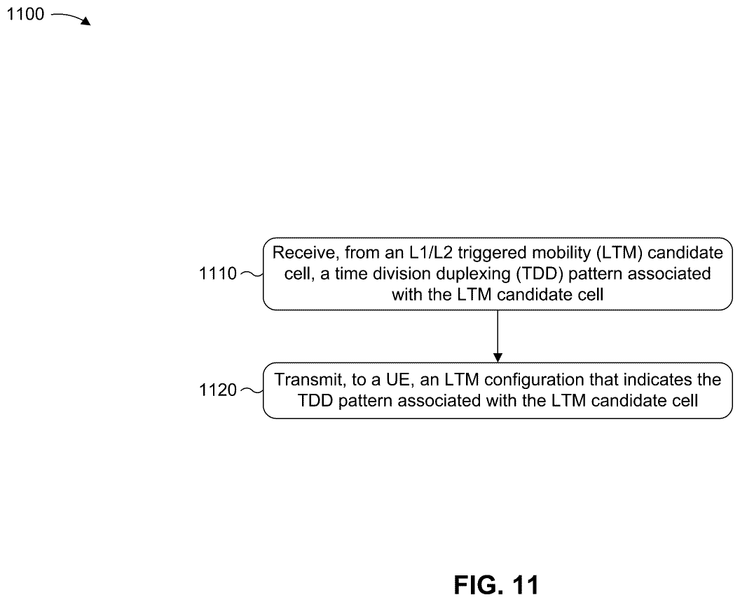

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with a TDD pattern indication for LTM, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1000 of FIG. 10, process 1000 of FIG. 10, or other processes as described herein. In some examples, executing instructions may include running the instructions, converting the instructions, compiling the instructions, and/or interpreting the instructions, among other examples.

In some aspects, the UE 120 includes means for receiving an LTM configuration that indicates a TDD pattern associated with an LTM candidate cell; and/or means for performing early uplink synchronization with the LTM candidate cell, wherein performing the early uplink synchronization includes identifying one or more valid ROs in the LTM candidate cell in accordance with the TDD pattern associated with the LTM candidate cell (e.g., the UE 120 may identify the one or more valid ROs in accordance with an early uplink synchronization with the LTM candidate cell). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for receiving, from an LTM candidate cell, a TDD pattern associated with the LTM candidate cell; and/or means for transmitting, to a UE 120, an LTM configuration that indicates the TDD pattern associated with the LTM candidate cell. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

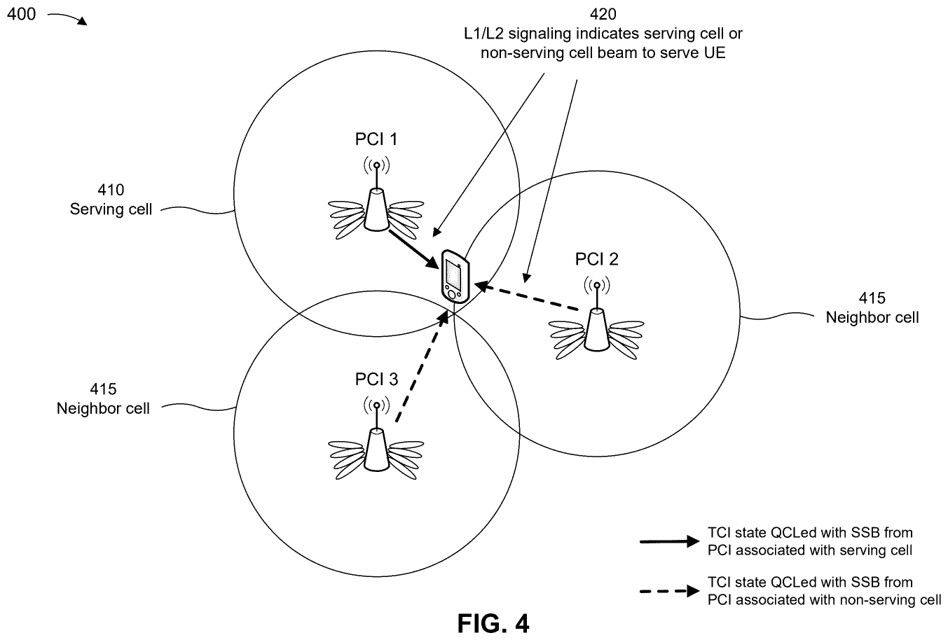

FIG. 4 is a diagram illustrating an example 400 of LTM. As shown in FIG. 4, example 400 includes communication between a UE, a network node that provides a serving cell 410 for the UE 120, and one or more network nodes associated with non-serving neighbor cells 415 of the serving cell 410. As described herein, example 400 relates to techniques to support efficient (e.g., low latency and/or low overhead) downlink and/or uplink beam management operations to support L1/L2-centric inter-cell mobility. For example, as described herein, LTM may generally include techniques that use L1/L2 signaling to activate and/or deactivate LTM candidate cells (e.g., cells configured for LTM), to trigger a handover to an activated LTM candidate cell, and/or to provide reference signals for measurement by a UE (e.g., such that the UE may select a candidate beam as a target beam in an LTM handover). Accordingly, one goal or principle underlying LTM is to enable a UE to perform a cell switch via dynamic control signaling at lower layers (e.g., DCI for L1 signaling or a MAC-CE for L2 signaling), rather than semi-static L3 RRC signaling, in order to reduce latency, reduce overhead, reduce complexity and/or processing burdens on a UE, and/or to otherwise increase efficiency of the cell switch.

For example, FIG. 4 illustrates an LTM technique that may be referred to as beam-based inter-cell mobility, dynamic point selection based inter-cell mobility, and/or non-serving cell-based inter-cell mobility, among other examples. As described herein, the LTM technique shown by example 400 may enable a network node to use L1 signaling (e.g., DCI) or L2 signaling (e.g., a MAC-CE) to indicate that the UE is to communicate on an access link using a beam from the serving cell 410 or a non-serving neighbor cell 415. For example, in a wireless network where LTM is not supported (e.g., cell switches are triggered only by an L3 handover), beam selection for control information and for data is typically limited to beams within a physical cell identity (PCI) associated with a serving cell 410. In contrast, in a wireless network that supports the LTM technique shown by example 400, beam selection for control and data may be expanded to include any beams within the serving cell 410 or one or more non-serving neighbor cells 415 that are configured for LTM (e.g., LTM candidate cells).

For example, as shown in FIG. 4, a UE may be configured with a single serving cell 410, and may be further configured with a neighbor cell set that includes one or more non-serving neighbor cells 415 configured for LTM. In some cases, the serving cell 410 and the non-serving neighbor cell(s) 415 configured for LTM may be associated with a common CU and a common DU, or the serving cell 410 and the non-serving neighbor cell(s) 415 configured for LTM may be associated with a common CU and different DUs. In some aspects, as shown by reference number 420, a network node may trigger an LTM handover for the UE using L1/L2 signaling (e.g., DCI or a MAC-CE) that indicates a selected transmission configuration indication (TCI) state quasi co-located (QCLed) with a reference signal (e.g., an SSB) associated with a PCI. For example, in the scenario shown in FIG. 4, the UE may be communicating with the serving cell 410 using a TCI state that is QCLed with an SSB from a PCI associated with the serving cell 410 (e.g., shown as PCI 1 in FIGS. 4), and L1/L2 signaling may trigger inter-cell mobility by indicating that the UE is to switch to communicating using a TCI state that is QCLed with an SSB from a PCI associated with a non-serving neighbor cell 415 (e.g., shown as PCI 2 or PCI 3 in FIG. 4). Accordingly, in the LTM technique shown by example 400, a serving network node (e.g., the common CU controlling the serving cell 410 and the non-serving neighbor cell(s) 415) may use L1/L2 signaling to select a beam from either the serving cell 410 or a non-serving neighbor cell 415 to serve the UE. In this way, relative to restricting L1/L2 beam selection to beams within the serving cell 410, the LTM technique shown in FIG. 4 may be more robust against blocking and provide more opportunities for higher rank spatial division multiplexing across different cells.

As indicated above, FIG. 4 is provided as an example. Other examples may differ from what is described with regard to FIG. 4.

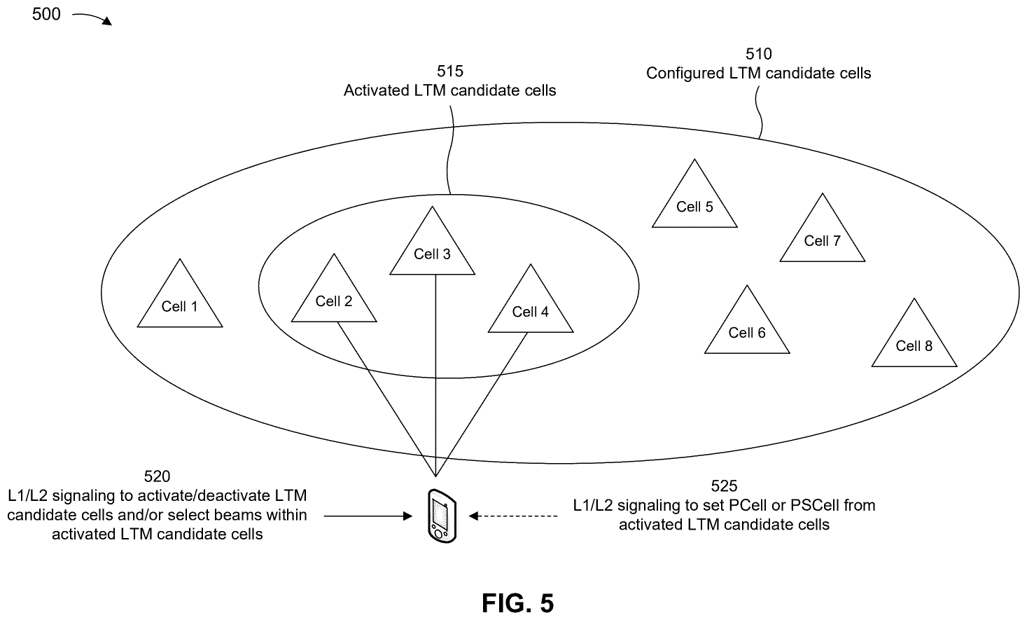

FIG. 5 is a diagram illustrating an example 500 of LTM. As shown in FIG. 5, example 500 includes communication between a UE and a set of network nodes that provide or are otherwise associated with cells that are configured for LTM. For example, as described herein, example 500 relates to an LTM technique that uses L1/L2 signaling to activate and/or deactivate LTM candidate cells (e.g., cells configured for LTM), to trigger a handover to an activated LTM candidate cell, and/or to provide reference signals for measurement by a UE (e.g., such that the UE may select a candidate beam as a target beam in an LTM handover) to reduce latency, reduce overhead, reduce complexity and/or processing burdens on a UE, and/or to otherwise increase efficiency of a cell switch relative to a legacy handover that is performed using semi-static L3 RRC signaling. For example, as described herein, example 500 may be referred to as serving cell-based inter-cell mobility, and may enable a network node to use L1/L2 signaling (e.g., DCI or a MAC-CE) to indicate control information associated with an activated cell set and/or a deactivated cell set and/or to indicate a change to a special cell (SpCell) within an activated cell set.

For example, as shown in FIG. 5, mechanisms that are generally similar to carrier aggregation may be used to enable LTM, except that different cells configured for LTM may be on the same carrier frequency. As shown in FIG. 5, a network node may configure a set of LTM candidate cells 510 (e.g., using RRC signaling), where each cell in the configured set of LTM candidate cells 510 may be referred to as an LTM candidate cell. As further shown, a set of activated LTM candidate cells 515 may include one or more LTM candidate cells in the configured set of LTM candidate cells 510 that are activated and ready to use for data and/or control transfer. Accordingly, in the LTM technique shown in FIG. 5, a deactivated cell set may include one or more LTM candidate cells that are included in the configured set of LTM candidate cells 510 and not included in the activated set of LTM candidate cells 515. However, the deactivated LTM candidate cells can be readily activated, and thereby added to the activated set of LTM candidate cells 515, using L1/L2 signaling. Accordingly, as shown by reference number 520, L1/L2 signaling can be used for mobility management of the activated set of LTM candidate cells 515. For example, in some aspects, L1/L2 signaling can be used to activate cells within the configured set of LTM candidate cells 510 (e.g., to add LTM candidate cells to the activated set of LTM candidate cells 515), to deactivate cells in the activated set of LTM candidate cells 515, and/or to select beams within the cells included in the activated set of LTM candidate cells 515. In this way, the LTM technique shown by example 500 may enable seamless mobility among the LTM candidate cells included in the activated set of LTM candidate cells 515 using L1/L2 signaling (e.g., using beam management techniques).

Furthermore, as shown by reference number 525, the LTM technique shown in FIG. 5 enables L1/L2 signaling to be used to set or change an SpCell (e.g., a primary cell (PCell) or primary secondary cell (PSCell)) from the cells included in the activated set of LTM candidate cells 515. Additionally, or alternatively, when the cell to become the new SpCell is in the deactivated set of LTM candidate cells (e.g., is included in the configured set of LTM candidate cells 510 but not the activated set of LTM candidate cells 515), L1/L2 signaling can be used to move the cell from the deactivated set of LTM candidate cells to the activated set of LTM candidate cells 515, and further L1/L2 signaling may then be used to set the cell as the new SpCell. Accordingly, the LTM technique shown by example 500 can provide more efficient cell switching to support multi-beam operation, enabling lower latency and reduced overhead by using L1signaling (e.g., DCI) and/or L2 signaling (e.g., a MAC-CE) rather than L3 signaling (e.g., RRC) to change a beam or trigger a cell switch for a UE.

As indicated above, FIG. 5 is provided as an example. Other examples may differ from what is described with regard to FIG. 5.

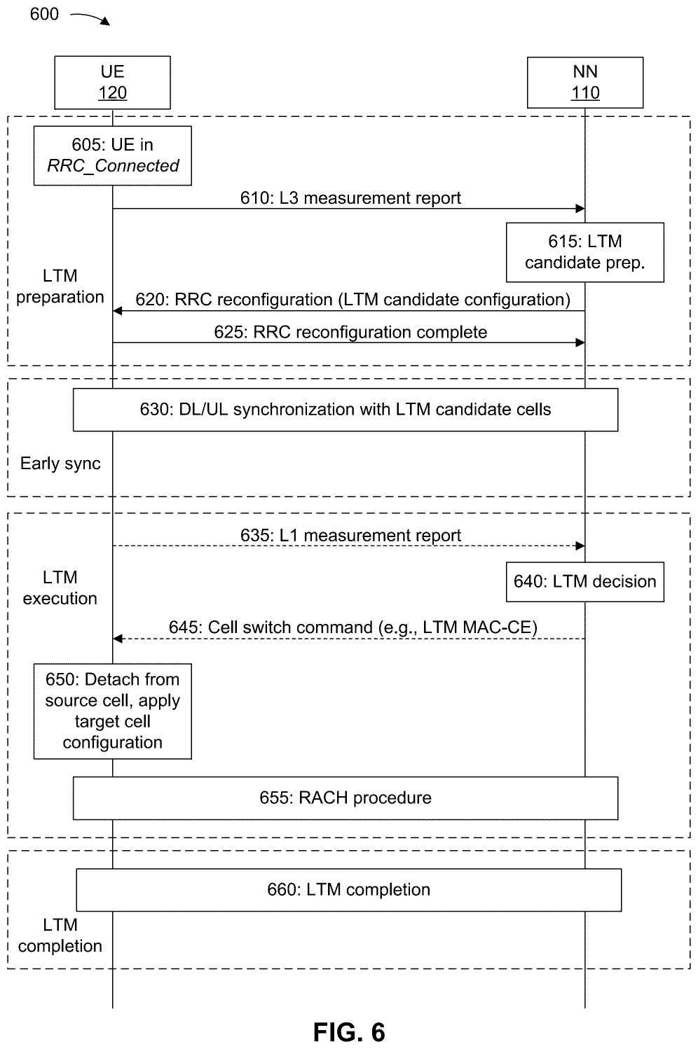

FIG. 6 is a diagram illustrating an example 600 of an LTM procedure. As shown in FIG. 6, example 600 includes communication between a network node 110 and a UE 120. In some aspects, the network node 110 and the UE 120 may communicate in a wireless network, such as wireless network 100. The network node 110 and the UE 120 may communicate via a wireless access link, which may include an uplink and a downlink.

In some examples, the network node 110 may instruct the UE 120 to change or switch serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using an L3 handover procedure, which may be referred to herein as a legacy handover procedure. In an L3 handover procedure, the network node 110 may transmit, to the UE 120, an RRC reconfiguration message indicating that the UE 120 is to perform a handover procedure to a target cell. For example, the network node 110 may transmit the reconfiguration message triggering the handover to the target cell in response to the UE 120 providing the network node 110 with an L3 measurement report indicating signal strength measurements associated with one or more cells (e.g., measurements associated with the source cell and/or one or more neighboring cells). In response to the RRC reconfiguration message, the UE 120 may communicate with the source cell and the target cell to detach from the source cell and connect to the target cell (e.g., the UE 120 may perform a contention-free RACH procedure in the target cell to establish an RRC connection with the target cell in accordance with a contention-free random access (CFRA) configuration indicated in the RRC reconfiguration message). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

As described herein, L3 handover procedures may be associated with high latency and high overhead due to the multiple RRC reconfiguration messages and/or other L3 signaling and operations used to perform the handover procedures. Accordingly, in some examples, a UE 120 may be configured to perform an LTM procedure, such as the LTM procedure shown in FIG. 6, which uses L1/L2 signaling to significantly reduce a handover latency relative to a legacy L3 handover procedure. For example, as shown in FIG. 6, the LTM procedure may include an LTM preparation phase, an early synchronization phase (shown as “early sync” in FIG. 6), an LTM execution phase, and an LTM completion phase.

As shown by reference number 605, during the LTM preparation phase, the UE 120 may be in an RRC connected state (sometimes referred to as RRC_Connected) with a source cell provided by the network node 110. As shown by reference number 610, the UE 120 may transmit, and the network node 110 may receive, an L3 measurement report (sometimes referred to as a MeasurementReport), which may indicate measurements related to a signal strength (e.g., RSRP measurements, RSSI measurements, RSRQ measurements, and/or CQI values) or other suitable measurements associated with the source cell and/or one or more neighboring cells. In some examples, based at least in part on the L3 measurement report or other information, the network node 110 may configure LTM for UE 120. Accordingly, as shown by reference number 615, the network node 110 may perform LTM candidate preparation. For example, during the LTM candidate preparation, the network node 110 may obtain configuration information for one or more LTM candidate cells (e.g., one or more parameters related to an identity for each LTM candidate cell, a synchronization and/or measurement configuration for each LTM candidate cell, and/or a full RRC configuration message associated with each LTM candidate cell, among other examples).

As shown by reference number 620, the network node 110 may transmit, and the UE 120 may receive, an RRC reconfiguration message (sometimes referred to as an RRCReconfiguration message), which may include an LTM configuration. More particularly, the LTM configuration included in the RRC reconfiguration message may indicate the configuration information for one or more LTM candidate cells (e.g., obtained during the LTM candidate preparation), which may be candidate cells to become a serving cell of the UE 120 and/or cells for which the UE 120 may later be triggered to perform an LTM procedure. As shown by reference number 625, the UE 120 may store the configuration information for the one or more LTM candidate cells and may transmit, in response to the RRC reconfiguration message, an RRC reconfiguration complete message (sometimes referred to as an RRCReconfigurationComplete message) to the network node 110.

As shown by reference number 630, during the early synchronization phase, the UE 120 may optionally perform downlink synchronization and/or uplink synchronization with the LTM candidate cells associated with the one or more LTM candidate cell configurations. For example, the UE 120 may perform downlink synchronization and timing advance acquisition with the one or more LTM candidate cells prior to receiving an LTM cell switch command. In some aspects, performing the early synchronization with the one or more candidate cells may reduce latency associated with performing a RACH procedure later in the LTM procedure, which is described in more detail below in connection with reference number 655. For example, the UE 120 may acquire the timing advance for an LTM candidate cell in accordance with a measured timing advance indicated in the configuration information for the LTM candidate cell and/or by using PRACH transmission parameters indicated in the configuration information (e.g., in an early synchronization configuration, which may be provided in an EarlyUL-SyncConfig parameter) to transmit a PRACH to the LTM candidate cell.

As shown by reference number 635, during the LTM execution phase, the UE 120 may obtain L1 measurements associated with the configured LTM candidate cells, and may transmit, to the network node 110, one or more L1 measurement reports associated with the configured LTM candidate cells. As shown by reference number 640, based at least in part on the L1 measurement report(s), the network node 110 may decide to execute an LTM cell switch to an LTM target cell (e.g., included among the configured LTM candidate cells). Accordingly, as shown by reference number 645, the network node 110 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the LTM target cell. As shown by reference number 650, based at least in part on the cell switch command, the UE 120 may switch to the configuration of the LTM target cell (e.g., the UE 120 may detach from the source cell and apply the configuration of the LTM target cell). Moreover, as shown by reference number 655, the UE 120 may perform a RACH procedure towards the LTM target cell, such as when a timing advance associated with the target cell is not available (e.g., in cases in which the UE 120 did not perform the early synchronization described above in connection with reference number 630 and/or the LTM cell switch command does not indicate a valid timing advance for the LTM target cell).

As shown by reference number 660, during the LTM completion phase, the UE 120 may indicate successful completion of the LTM cell switch towards the LTM target cell. In this way, a cell switch or handover to a target cell may be performed using L1/L2 signaling, which is associated with less overhead than an L3 handover procedure and/or a reduced latency relative to an L3 handover procedure.

As indicated above, FIG. 6 is provided as an example. Other examples may differ from what is described with regard to FIG. 6.

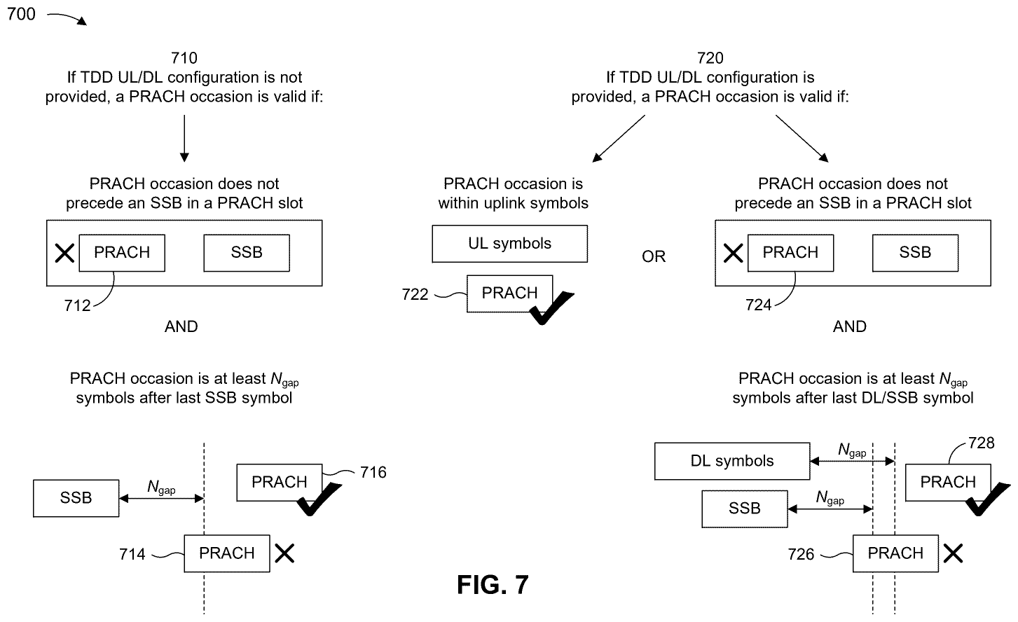

FIG. 7 is a diagram illustrating examples 700 of mapping valid ROs. For example, from a physical layer perspective at a UE 120, a four-step RACH procedure, also known as a Type-1 random access procedure, includes transmission of a random access preamble (Msg1) in a valid RO (sometimes called a PRACH occasion), reception of a random access response (RAR) message with a PDCCH/PDSCH (Msg2), and when applicable, transmission of a PUSCH scheduled by an uplink grant in the RAR (Msg3) and reception of a PDSCH for contention resolution (Msg4). Additionally, or alternatively, in a two-step RACH procedure, also known as a Type-2 random access procedure, a UE 120 transmits a random access preamble in a valid RO and transmits a PUSCH payload (collectively referred to as MsgA) and the UE 120 then receives a RAR message with a PDCCH/PDSCH (MsgB). Furthermore, when applicable, the UE 120 transmits a PUSCH scheduled by a fallback uplink grant in the RAR and receives a PDSCH for contention resolution. In either case, when a RACH procedure is triggered (e.g., by higher layers at the UE 120 and/or by a PDCCH order message received from a network node 110), the UE 120 may determine an RO (e.g., corresponding to time and frequency resources for a PRACH transmission) in which to transmit the random access preamble, also known as a PRACH, according to an SSB-RO mapping.

For example, prior to initiation of a RACH procedure or transmission of a PRACH, a network node 110 may provide a UE 120 with random access configuration information that indicates PRACH transmission parameters (e.g., a PRACH preamble format, time/frequency resources for PRACH transmission, a preamble index, and/or a preamble subcarrier spacing (SCS), among other examples). Furthermore, the UE 120 may receive an indication of one or more SSB indexes in an ssb-PositionsInBurst parameter (e.g., indicated in SIB1 and/or a ServingCellConfigCommon parameter) that are mapped to valid ROs. For example, the SSB indexes indicated in the ssb-PositionsInBurst parameter are mapped to valid ROs in an increasing order of preamble indexes within a single RO, then in an increasing order of frequency resource indexes for frequency multiplexed ROs, then in an increasing order of time resource indexes for time multiplexed ROs within a PRACH slot, and then in an increasing order of indexes for PRACH slots. In this way, when a PRACH transmission is triggered at the UE 120, the UE 120 may transmit a PRACH preamble in a valid RO that is mapped to an SSB index (e.g., an SSB index indicated in a PDCCH order triggering the PRACH transmission or an SSB index selected by the UE 120). Accordingly, because the UE 120 transmits the PRACH preamble in a valid RO that is mapped to or otherwise associated with an SSB index, the UE 120 may apply one or more validation rules to determine whether an RO is valid or invalid. For example, in paired spectrum or a supplementary uplink band, all ROs are valid. However, for unpaired spectrum (e.g., a TDD band), an RO must satisfy one or more validation rules to be considered valid.

For example, as shown in FIG. 7, the validation rules that are applied to determine whether an RO is valid or invalid may depend on whether a UE 120 has been provided with a parameter that indicates an uplink and downlink TDD configuration, or TDD pattern. For example, the uplink and downlink TDD configuration may be indicated in a tdd-UL-DL-ConfigurationCommon parameter, and may include a periodicity of a TDD pattern, a number of consecutive full downlink slots that begin each TDD pattern, a number of consecutive downlink symbols in the beginning of a slot that follows a last full downlink slot, a number of consecutive full uplink slots that end each TDD pattern, and a number of consecutive uplink symbols in the end of a slot that precedes a first full uplink slot. Accordingly, as described herein, the UE 120 may apply a first set of validation rules to determine whether an RO is valid in cases where the uplink and downlink TDD configuration has not been provided, and may apply a second set of validation rules to determine whether an RO is valid in cases where the uplink and downlink TDD configuration has been provided.

For example, as shown by reference number 710, if the UE 120 has not been provided with an uplink and downlink TDD configuration, an RO in a PRACH slot is valid if the RO does not precede an SSB in the PRACH slot and starts at least N_{gap} symbols after a last SSB reception symbol, where N_{gap} may have a value that depends on a preamble SCS (e.g., N_{gap} may have a value of 0 for a preamble SCS of 1.25 kilohertz (kHz) or 5 kHz, 2 for a preamble SCS of 15 kHz, 30 kHz, 60 kHz, or 120 kHz, 8 for a preamble SCS of 480 kHz, or 16 for a preamble SCS of 960 kHz). Furthermore, in cases where a semi-static channel access mode is configured, a valid RO cannot overlap with a set of consecutive symbols before the start of a next channel occupancy time where the UE 120 does not transmit. Otherwise, an RO that fails to satisfy the applicable validation rules is considered invalid for SSB-RO mapping purposes and for PRACH transmission. For example, FIG. 7 depicts an RO 712 that is invalid because the RO 712 precedes an SSB in the PRACH slot. Furthermore, FIG. 7 depicts an RO 714 that is invalid because the RO 714 is fewer than N_{gap} symbols after a last SSB reception symbol. On the other hand, an RO 716 that does not precede an SSB in a PRACH slot and is at least N_{gap} symbols after a last SSB reception symbol is considered valid.

Additionally, or alternatively, as shown by reference number 720, if the UE 120 has been provided with an uplink and downlink TDD configuration, an RO is valid if the RO is within uplink symbols. For example, FIG. 7 depicts an RO 722 that is valid because the RO 722 is within uplink symbols. Alternatively, if an RO is not within uplink symbols (e.g., is within downlink or flexible symbols), the RO is valid only if the RO does not precede an SSB in a PRACH slot and starts at least N_{gap} symbols after a last downlink symbol and least N_{gap} symbols after a last SSB symbol, where N_{gap} may have a value that depends on a preamble SCS. Furthermore, in cases where a semi-static channel access mode is configured, a valid RO cannot overlap with a set of consecutive symbols before the start of a next channel occupancy time where no transmissions are permitted. Otherwise, an RO that fails to satisfy the applicable validation rules is considered invalid for SSB-RO mapping purposes and for PRACH transmission. For example, FIG. 7 depicts a RO 724 that is invalid because the RO 724 precedes an SSB in the PRACH slot. Furthermore, FIG. 7 depicts a RO 726 that is invalid because the RO 726 is fewer than N_{gap} symbols after a last downlink symbol and fewer than N_{gap} symbols after a last SSB symbol. On the other hand, a RO 728 that does not precede an SSB in a PRACH slot and is at least N_{gap} symbols after a last downlink symbol and a last SSB reception symbol is considered valid.

As indicated above, FIG. 7 is provided as an example. Other examples may differ from what is described with regard to FIG. 7.

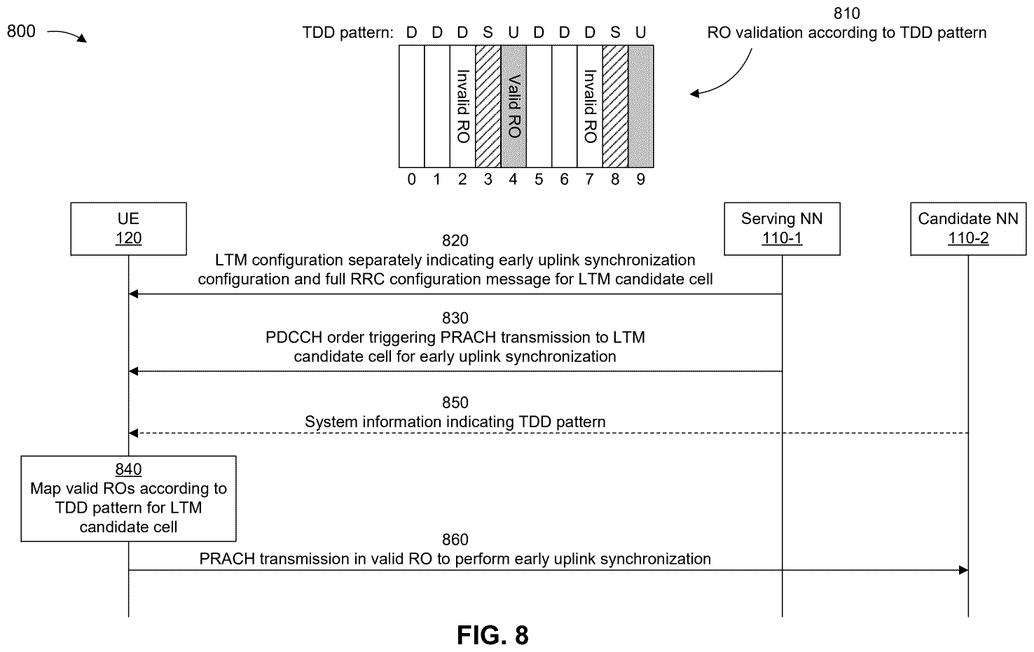

FIG. 8 is a diagram illustrating an example 800 of mapping valid ROs in accordance with a TDD pattern. As shown in FIG. 8, example 800 includes communication between a UE 120, a serving network node 110-1, and a candidate network node 110-2. In some aspects, the UE 120, the serving network node 110-1, and the candidate network node 110-2 may communicate in a wireless network, such as wireless network 100. The UE 120 may communicate with the serving network node 110-1 and/or the candidate network node 110-2 via a wireless access link, which may include an uplink and a downlink. The serving network node 110-1 may communicate with the candidate network node 110-2 via a wired or wireless backhaul link. As described herein, the serving network node 110-1 may provide a serving cell for the UE 120, and the candidate network node 110-2 may provide a candidate LTM cell that may be configured for the UE 120.

As described herein, when a RACH procedure is triggered at the UE 120 (e.g., by higher layers at the UE 120 and/or by a PDCCH order message received from the serving network node 110-1), the UE 120 may generally transmit a PRACH in an RO associated with a target cell in order to establish a connected state or synchronization with the target cell. Furthermore, in order to determine the RO in which to transmit the PRACH, the UE 120 maps one or more SSBs to valid ROs, which may be defined according to various validation rules. For example, when the UE 120 is provided with a TDD configuration of a target cell, an RO is valid if the RO is within uplink symbols, or if the RO does not precede an SSB in a PRACH slot and starts at least N_{gap} symbols after a last downlink symbol and least N_{gap} symbols after a last SSB symbol. For example, as shown by reference number 810 in FIG. 8, a target cell may operate in unpaired spectrum according to a TDD pattern (e.g., “DDDSU”) that repeats according to a periodicity, and the UE 120 may perform RO validation for the target cell according to the TDD pattern (e.g., where any ROs that are in uplink symbols are valid), and any ROs that are in downlink or special/flexible symbols are invalid unless the RO does not precede an SSB in a PRACH slot and starts at least N_{gap} symbols after a last downlink symbol and least N_{gap} symbols after a last SSB symbol. For example, in FIG. 8, a target cell has a first RO configured in a third interval (associated with index #2), a second RO configured in a fifth interval (associated with index #4), and a third RO configured in an eighth interval (associated with index #7). Accordingly, when validating ROs associated with the target cell according to the TDD pattern of the target cell, the UE 120 may determine that the second RO is valid in accordance with the second RO being within uplink symbols, and may determine that the first and third ROs are invalid in accordance with the first and third ROs being within downlink symbols and either preceding an SSB in a PRACH slot, starting fewer than N_{gap} symbols after a last downlink symbol, or starting fewer than N_{gap} symbols after a last SSB symbol.

As described herein, a network node 110 may generally transmit system information that indicates a RACH configuration to enable a UE 120 to identify valid ROs in which to transmit a PRACH. For example, the RACH configuration transmitted in system information may include an RO configuration (e.g., RACH-ConfigGeneric) that indicates a time domain configuration for one or more ROs (e.g., using a prach-ConfigurationIndex information element (IE)) and a frequency domain configuration for the one or more ROs (e.g., using msg1-FDM and/or msg1-FrequencyStart IEs). In addition, the system information may include a serving cell configuration (e.g., ServingCellConfigCommon) that indicates the TDD pattern associated with network node 110 (e.g., in a TDD-UL-DL-ConfigCommon IE) for RO validation. Similarly, when a serving network node 110 transmits a handover command to a UE 120 to trigger a legacy L3 handover to a target cell, the handover command may include an RRC configuration for the target cell that indicates the RO configuration and the TDD pattern associated with the target cell. For example, the RRC configuration for the target cell may include a synchronization or RACH configuration (e.g., ReconfigurationWithSync) that indicates a CFRA configuration (e.g., rach-ConfigDedicated) associated with the target cell and the serving cell configuration (e.g., ServingCellConfigCommon) that indicates the TDD pattern associated with network node 110. Accordingly, when the UE 120 receives the handover command, the UE 120 may parse the RRC configuration associated with the target cell to identify the CFRA configuration of the target cell. In addition, the UE 120 obtains the TDD pattern to validate ROs in the target cell from the RRC configuration for the target cell.

However, in an LTM context, one or more LTM candidate cells are configured for a UE 120 in an LTM configuration, which indicates RACH resources to enable early uplink synchronization with an LTM candidate cell (e.g., prior to a cell switch command triggering an LTM handover to the LTM candidate cell). The early uplink synchronization configuration is indicated (e.g., in an EarlyUL-SyncConfig IE) separately from a full RRC reconfiguration message of the LTM candidate cell in order to conserve resources and/or reduce a processing burden on the UE 120 (e.g., because the UE 120 does not have to parse the RRC reconfiguration message for the LTM candidate cell, which typically has a large payload size, before receiving an LTM cell switch command triggering a handover to the LTM candidate cell). However, the TDD pattern of the LTM candidate cell, which the UE 120 needs to validate the ROs that can be used to transmit a PRACH for the early uplink synchronization, is not separately provided to the UE 120. Thus, to obtain the TDD pattern of the LTM candidate cell, the UE 120 has to either acquire system information (e.g., ServingCellConfigCommonSIB) indicating the TDD pattern or parse the full RRC reconfiguration message associated with the LTM candidate cell before the actual cell switch is triggered, which undermines the benefit of separately providing the early uplink synchronization configuration for LTM to reduce the processing burden on the UE 120.

For example, as shown by reference number 820, the serving network node 110-1 may transmit, and the UE 120 may receive, an LTM configuration that separately indicates an early uplink synchronization configuration and a full RRC configuration message for the candidate network node 110-2 that is configured as an LTM candidate cell. As described herein, the LTM configuration (e.g., LTM-Config) includes an LTM candidate cell configuration that indicates an identifier and a PCI associated with the candidate network node 110-2, an SSB configuration or other information for enabling downlink synchronization with the candidate network node 110-2, and a TCI state configuration indicating one or more TCI states or reference signal resources or resource sets associated with the candidate network node 110-2. In addition, the LTM candidate cell configuration includes an early uplink synchronization configuration that the UE 120 can use to acquire a valid timing advance for the candidate network node 110-2 prior to an LTM cell switch. For example, the early uplink synchronization configuration may indicate PRACH transmission parameters such as an RO configuration (e.g., RACH-ConfigGeneric), a preamble SCS, a preamble index, a number of SSBs per RO, and/or a timing advance offset, among other examples. In addition, the LTM candidate cell configuration indicates a full RRC reconfiguration message associated with the candidate network node 110-2.

As further shown by reference number 830, the serving network node 110-1 may transmit, and the UE 120 may receive, a PDCCH order that triggers a PRACH transmission to the candidate network node 110-2 for early uplink synchronization. For example, the PDCCH order may indicate a RACH preamble index that the UE 120 is to use for CFRA in the candidate network node 110-2. As described above, the early uplink synchronization for the candidate network node 110-2 is indicated in the LTM configuration separately from the full RRC configuration message associated with the candidate network node 110-2. Accordingly, the UE 120 is not required to parse or otherwise process the full RRC configuration of the candidate network node 110-2 in order to obtain the PRACH transmission parameters for the candidate network node 110-2, and the UE 120 is allowed to wait to parse or otherwise process the full RRC configuration of the candidate network node 110-2 until an LTM cell switch command is received triggering an LTM handover to the candidate network node 110-2.

However, as shown by reference number 840, the UE 120 generally has to map valid ROs associated with the candidate network node 110-2 in order to determine a valid RO in which to transmit a PRACH for early uplink synchronization. For example, an RO associated with the candidate network node 110-2 is generally valid if the RO is within uplink symbols, or the RO otherwise has to satisfy certain conditions relative the timing of SSBs in order to be valid. Accordingly, an important factor that the UE 120 evaluates when mapping valid ROs is whether an RO is within uplink symbols, as indicated by a TDD configuration (e.g., tdd-UL-DL-ConfigurationCommon) indicating the TDD pattern of the candidate network node 110-2. However, because the TDD pattern of the candidate network node 110-2 is not separately indicated to the UE 120 within the LTM configuration, the UE 120 has to expend processing resources to parse the full RRC configuration message contained in the LTM configuration to obtain the TDD pattern associated with the candidate network node 110-2 and use the TDD pattern obtained from the full RRC configuration message to map valid ROs associated with the candidate network node 110-2. Alternatively, as shown by reference number 850, the UE 120 may acquire and decode a system information block (SIB) broadcasted by the candidate network node 110-2 (e.g., ServingCellConfigCommonSIB) to obtain the TDD pattern used to validate ROs for the candidate network node 110-2. As shown by reference number 860, the UE 120 may then transmit a PRACH in a valid RO to perform early uplink synchronization with the candidate network node 110-2.

Accordingly, because acquiring system information or parsing the full RRC reconfiguration message associated with an LTM candidate cell to obtain the TDD pattern of the LTM candidate cell before an LTM cell switch is triggered negates the purpose of separately providing the early uplink synchronization configuration for the LTM candidate cell, various aspects described herein generally relate to indicating a TDD pattern associated with an LTM candidate cell within an LTM configuration associated with LTM candidate cell. More particularly, as described herein, the TDD pattern associated with the LTM candidate cell is indicated separately from the full RRC configuration message associated with the LTM candidate cell. For example, in some aspects, a serving network node may obtain the TDD pattern associated with the LTM candidate cell and provide the LTM configuration indicating the TDD pattern associated with the LTM candidate cell to the UE the during an LTM preparation stage. In some aspects, the LTM configuration may indicate the TDD pattern associated with the LTM candidate cell and the early uplink synchronization configuration associated with the LTM candidate cell at the same hierarchical level, or the LTM configuration may indicate the TDD pattern as a parameter within the early uplink synchronization configuration associated with the LTM candidate cell. Accordingly, when the UE receives a PDCCH order or another suitable event triggers a PRACH transmission in the LTM candidate cell, the UE may identify a valid RO according to the indicated TDD pattern and may transmit a PRACH in the valid RO to acquire a valid timing advance for the LTM candidate cell before receiving an LTM cell switch command.

As indicated above, FIG. 8 is provided as an example. Other examples may differ from what is described with regard to FIG. 8.

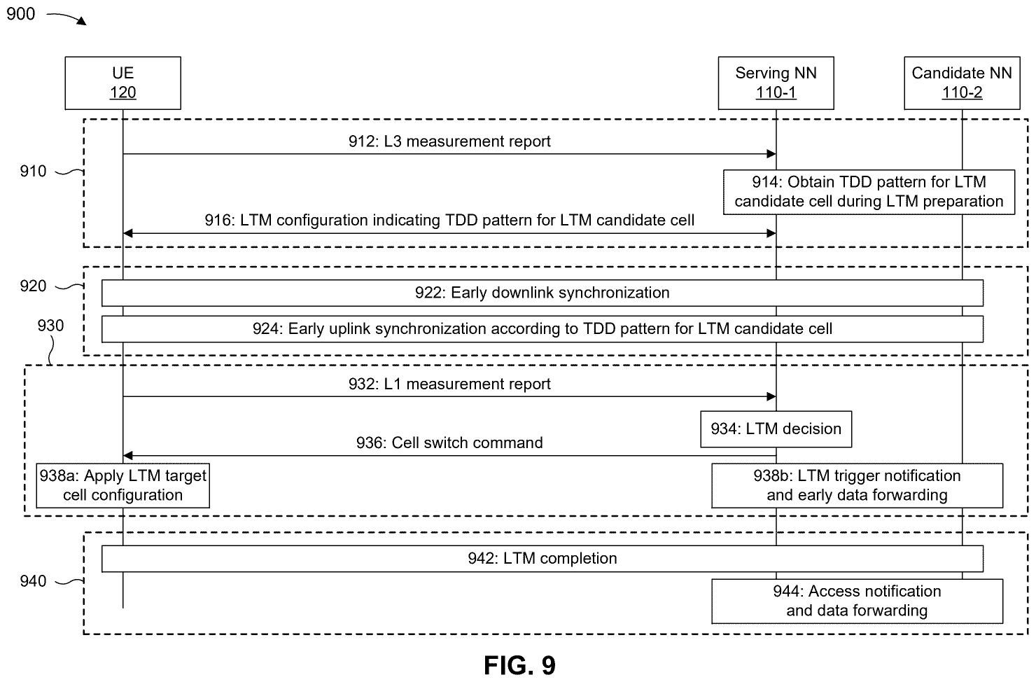

FIG. 9 is a diagram illustrating an example 900 associated with associated with a TDD pattern indication for LTM. As shown in FIG. 9, example 900 includes communication between a UE 120, a serving network node 110-1, and a candidate network node 110-2. In some aspects, the UE 120, the serving network node 110-1, and the candidate network node 110-2 may communicate in a wireless network, such as wireless network 100. The UE 120 may communicate with the serving network node 110-1 and/or the candidate network node 110-2 via a wireless access link, which may include an uplink and a downlink. The serving network node 110-1 may communicate with the candidate network node 110-2 via a wired or wireless backhaul link. As described herein, the serving network node 110-1 may provide a serving cell for the UE 120, and the candidate network node 110-2 may provide a candidate LTM cell that may be configured for the UE 120.

As shown in FIG. 9, example 900 includes various operations associated with or related to LTM configurations and LTM handovers, which use L1/L2 signaling to significantly reduce a handover latency relative to a legacy L3 handover procedure. For example, as shown in FIG. 9 and described in more detail herein, the operations associated with or related to LTM configurations and LTM handovers may occur during an LTM preparation phase 910, an early synchronization phase 920, an LTM execution phase 930, and an LTM completion phase 940.

As shown by reference number 912, during the LTM preparation phase 910, the UE 120 may transmit, and the serving network node 110-1 may receive, an L3 measurement report while the UE 120 is in an RRC connected state in a source cell provided by the serving network node 110-1. In some aspects, the L3 measurement report may indicate measurements related to a signal strength (e.g., RSRP measurements, RSSI measurements, RSRQ measurements, and/or CQI values) or other suitable measurements associated with the source network node 110-1 and/or one or more neighboring cells, such as the candidate network node 110-2.

As further shown by reference number 914, the serving network node 110-1 may initiate LTM candidate preparation for the UE 120 in accordance with the L3 measurement report provided by the UE 120 or other suitable information, where the LTM candidate preparation may include obtaining a TDD pattern associated with the candidate network node 110-2. For example, during the LTM candidate preparation, the serving network node 110-1 may obtain a full RRC configuration message associated with the candidate network node 110-2 and may obtain an early uplink synchronization configuration for the candidate network node 110-2 (e.g., uplink frequency information, an RO configuration, a BWP configuration, a number of SSBs per RO, a PRACH root sequence index, a PRACH SCS, and/or a timing advance offset, among other examples). In addition, the serving network node 110-1 may obtain the TDD pattern associated with the candidate network node 110-2. For example, in some aspects, the serving network node 110-1 and the candidate network node 110-2 may be associated with different CUs, and the serving network node 110-1 may send a message to the candidate network node 110-2 via a backhaul link to request that the candidate network node 110-2 provide the TDD pattern of the candidate network node 110-2.

Accordingly, based at least in part on the request from the serving network node 110-1, the candidate network node 110-2 may provide the TDD pattern associated with the candidate network node 110-2 to the serving network node 110-1. For example, in some aspects, the candidate network node 110-2 may send a first message to the serving network node 110-1 indicating the TDD pattern associated with the candidate network node 110-2 and may separately send a second message to the serving network node 110-1 to indicate the full RRC configuration message associated with the candidate network node 110-2. Alternatively, the candidate network node 110-2 may send information indicating the TDD pattern associated with the candidate network node 110-2 and the full RRC configuration message associated with the candidate network node 110-2 together in a single message. Alternatively, the candidate network node 110-2 may send information indicating only the full RRC configuration message associated with the candidate network node 110-2, in which case the serving network node 110-1 may parse the full RRC configuration message associated with the candidate network node 110-2 to obtain a TDD configuration indicating the TDD pattern (e.g., in a TDD-UL-DL-ConfigCommon field within a ServingCellConfigCommon IE).

In some aspects, in addition to obtaining the full RRC configuration message for the candidate network node 110-2 and the TDD pattern associated with the candidate network node 110-2, the serving network node 110-1 may obtain other suitable information associated with the candidate network node 110-2 during the LTM candidate preparation. For example, in some aspects, the serving network node 110-1 may additionally obtain synchronization and measurement configuration information for the candidate network node 110-2, such as one or more parameters related to an identity for the candidate network node 110-2, a PCI associated with the candidate network node 110-2, an SSB configuration associated with the candidate network node 110-2, TCI state information associated with the candidate network node 110-2, and/or the early uplink synchronization configuration associated with the candidate network node 110-2.

As further shown by reference number 916, the serving network node 110-1 and the UE 120 may then communicate to perform an RRC reconfiguration in which the serving network node 110-1 transmits, and the UE 120 receives, an LTM configuration associated with the candidate network node 110-2 and indicating the TDD pattern of the candidate network node 110-2. For example, as described herein, the LTM configuration may generally include the identity information for the candidate network node 110-2, the synchronization information for the candidate network node 110-2, a measurement configuration information for the candidate network node 110-2, and the full RRC configuration message associated with the candidate network node 110-2. In addition, the LTM configuration may indicate the TDD pattern associated with the candidate network node 110-2 separately from the full RRC configuration message associated with the candidate network node 110-2. For example, in some aspects, the TDD pattern may be indicated within the LTM configuration at a same hierarchical level as the early uplink synchronization configuration indicated in the LTM configuration. Alternatively, in some aspects, the LTM configuration may indicate the TDD pattern as a field or IE within the early uplink synchronization configuration. The UE 120 may then store the configuration information for the candidate network node 110-2 and may transmit, in response to the RRC reconfiguration message, an RRC reconfiguration complete message to the serving network node 110-1.

In some aspects, the TDD pattern that the LTM configuration indicates for the candidate network node 110-2 may be identical to a TDD pattern indicated in the full RRC configuration message associated with the candidate network node 110-2 and/or the system information transmitted by the candidate network node 110-2. In such cases, the full RRC configuration message associated with the candidate network node 110-2 may omit the TDD pattern associated with the candidate network node 110-2, and the UE 120 may assume that the TDD pattern indicated in the LTM configuration applies after any LTM handover to the candidate network node 110-2. Alternatively, in some aspects, the TDD pattern indicated in the LTM configuration indicates may differ from the TDD pattern indicated in the full RRC configuration message associated with the candidate network node 110-2 and/or the system information transmitted by the candidate network node 110-2. In such cases, the UE 120 may assume that the TDD pattern indicated in the LTM configuration only applies to early uplink synchronization, and that the TDD pattern in the full RRC configuration message applies after any LTM handover to the candidate network node 110-2.

As shown by reference number 922, during the early synchronization phase 920, the UE 120 may perform downlink synchronization with the candidate network node 110-2 (e.g., in accordance with the SSB configuration, the TCI configuration, and/or other suitable configuration information indicated in the LTM configuration associated with the candidate network node 110-2).

As further shown by reference number 924, during the early synchronization phase 920, the UE 120 may perform uplink synchronization with the candidate network node 110-2. For example, as described herein, the UE 120 may obtain a set of PRACH transmission parameters that indicate an RO configuration, a number of SSBs per RO, and/or other suitable PRACH transmission parameters from the early uplink synchronization configuration provided in the LTM configuration for the candidate network node 110-2. In addition, the UE 120 may obtain the TDD pattern associated with the candidate network node 110-2 from the LTM configuration without parsing the full RRC configuration message associated with the candidate network node 110-2. Accordingly, the UE 120 may use the TDD pattern associated with the candidate network node 110-2 to map valid ROs associated with the candidate network node 110-2 and to select an RO in which to transmit a PRACH toward the candidate network node 110-2 upon receiving a PDCCH order from the serving network node 110-1. The UE 120 may then transmit the PRACH toward the candidate network node 110-2 (e.g., using a preamble index indicated in the PDCCH order) in a valid RO in order to acquire a valid timing advance and/or other uplink synchronization information associated with the candidate network node 110-2. Furthermore, in cases where the LTM configuration indicates the TDD pattern of the candidate network node 110-2 at the same hierarchical level as the early uplink synchronization, the UE 120 may use the TDD pattern to determine one or more valid reference signal occasions (e.g., CSI-RS occasions, tracking reference signal (TRS) occasions, or the like) for the candidate network node 110-2. For example, the UE 120 generally does not receive a CSI-RS that overlaps with uplink symbols in a TDD pattern, whereby the UE 120 may use the TDD pattern to determine one or more valid or invalid CSI-RS occasions, TRS occasions, and/or other suitable reference signal occasions in which to receive or not receive a reference signal.

As shown by reference number 932, during the LTM execution phase, the UE 120 may obtain L1 measurements associated with the configured LTM candidate cells, and may transmit, to the serving network node 110-1, one or more L1 measurement reports associated with the configured LTM candidate cells. As shown by reference number 934, based at least in part on the L1 measurement report(s), the serving network node 110-1 may decide to execute an LTM cell switch to the candidate network node 110-2. Accordingly, as shown by reference number 936, the serving network node 110-1 may transmit, and the UE 120 may receive, a MAC-CE or another suitable L1 or L2 message triggering an LTM cell switch (e.g., the message triggering the LTM cell switch may be referred to herein as a cell switch command, an LTM cell switch command MAC-CE, a MAC-CE carrying a cell switch command, or the like). The cell switch command may indicate a candidate configuration index associated with the candidate network node 110-2. As shown by reference number 938a, based at least in part on the cell switch command, the UE 120 may switch to the configuration of the candidate network node 110-2 (e.g., the UE 120 may detach from the source cell and apply the configuration of the candidate network node 110-2). Furthermore, the UE 120 may apply the TDD pattern indicated in the LTM configuration in cases where the TDD pattern indicated in the LTM configuration is the same as the TDD pattern in the full RRC configuration or system information associated with the candidate network node 110-2. Alternatively, when the TDD pattern indicated in the LTM configuration is different from the TDD pattern in the full RRC configuration or system information associated with the candidate network node 110-2, the UE 120 may parse the full RRC configuration message or decode system information associated with the candidate network node 110-2 to obtain the TDD pattern to apply after the cell switch. As further shown by reference number 938b, the serving network node 110-1 may send an LTM trigger notification to the candidate network node 110-2 and perform early data forwarding to the candidate network node 110-2 until the LTM handover is complete.

As shown by reference number 942, during the LTM completion phase 940, the UE 120 may indicate successful completion of the LTM cell switch towards the candidate network node 110-2. Furthermore, as shown by reference number 944, the serving network node 110-1 may send an access notification to the candidate network node 110-2 and perform data forwarding to the candidate network node 110-2 as needed after the LTM handover is complete.

As indicated above, FIG. 9 is provided as an example. Other examples may differ from what is described with regard to FIG. 9.

FIG. 10 is a diagram illustrating an example process 1000 performed, for example, at a UE or an apparatus of a UE. Example process 1000 is an example where the apparatus or the UE (e.g., UE 120) performs operations associated with a TDD pattern indication for LTM.

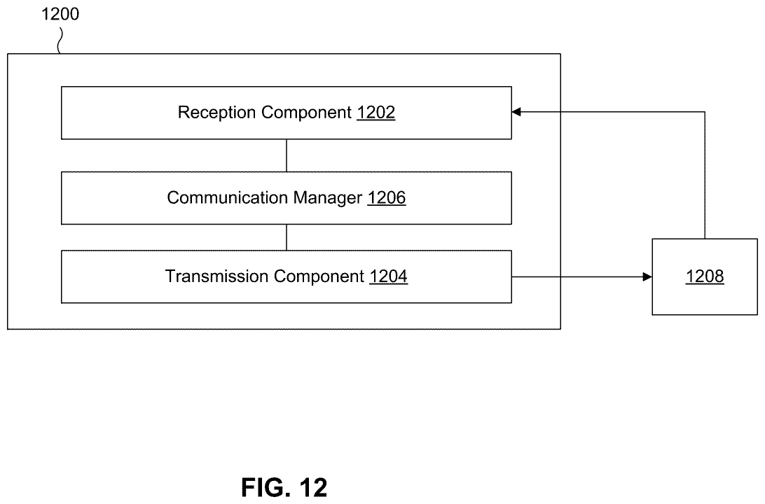

As shown in FIG. 10, in some aspects, process 1000 may include receiving an LTM configuration that indicates a TDD pattern associated with an LTM candidate cell (block 1010). For example, the UE (e.g., using reception component 1202 and/or communication manager 1206, depicted in FIG. 12) may receive an LTM configuration that indicates a TDD pattern associated with an LTM candidate cell, as described above.

As further shown in FIG. 10, in some aspects, process 1000 may include performing early uplink synchronization with the LTM candidate cell, wherein performing the early uplink synchronization includes identifying one or more valid ROs in the LTM candidate cell in accordance with the TDD pattern associated with the LTM candidate cell (block 1020). For example, the UE (e.g., using communication manager 1206, depicted in FIG. 12) may identify, in accordance with an early uplink synchronization with the LTM candidate cell, one or more valid ROs in the LTM candidate cell in accordance with the TDD pattern associated with the LTM candidate cell, as described above.

Process 1000 may include additional aspects, such as any single aspect or any combination of aspects described below and/or in connection with one or more other processes described elsewhere herein.

In a first aspect, the LTM configuration indicates an RRC configuration associated with the LTM candidate cell separately from the TDD pattern associated with the LTM candidate cell.

In a second aspect, alone or in combination with the first aspect, the TDD pattern indicated in the LTM configuration is identical to a TDD pattern indicated in an RRC configuration or system information associated with the LTM candidate cell.

In a third aspect, alone or in combination with one or more of the first and second aspects, process 1000 includes receiving, from a serving cell, a cell switch command triggering a handover from the serving cell to the LTM candidate cell, and communicating with the LTM candidate cell in accordance with the TDD pattern indicated in the LTM configuration after the handover is complete.

In a fourth aspect, alone or in combination with one or more of the first through third aspects, the TDD pattern indicated in the LTM configuration is different from a TDD pattern indicated in an RRC configuration or system information associated with the LTM candidate cell.

In a fifth aspect, alone or in combination with one or more of the first through fourth aspects, process 1000 includes receiving, from a serving cell, a cell switch command triggering a handover from the serving cell to the LTM candidate cell, and communicating with the LTM candidate cell in accordance with the TDD pattern indicated in the RRC configuration or the system information associated with the LTM candidate cell after the handover is complete.

In a sixth aspect, alone or in combination with one or more of the first through fifth aspects, the LTM configuration indicates the TDD pattern associated with the LTM candidate cell at a same level as an early uplink synchronization configuration associated with the LTM candidate cell.

In a seventh aspect, alone or in combination with one or more of the first through sixth aspects, performing the early uplink synchronization includes identifying one or more valid reference signal occasions in the LTM candidate cell in accordance with the TDD pattern associated with the LTM candidate cell.

In an eighth aspect, alone or in combination with one or more of the first through seventh aspects, the LTM configuration indicates the TDD pattern associated with the LTM candidate cell within an early uplink synchronization configuration associated with the LTM candidate cell.

In a ninth aspect, alone or in combination with one or more of the first through eighth aspects, the one or more valid ROs include one or more ROs that are within uplink symbols in a PRACH slot.

In a tenth eighth aspect, alone or in combination with one or more of the first through ninth aspects, the one or more valid ROs include one or more ROs that do not precede an SSB in a PRACH slot and start at least a threshold number of symbols after a last downlink symbol and at least the threshold number of symbols after a last SSB symbol in the PRACH slot.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a serving network node or an apparatus of a serving network node. Example process 1100 is an example where the apparatus or the serving network node (e.g., network node 110 or network node 110-1) performs operations associated with a TDD pattern indication for LTM.

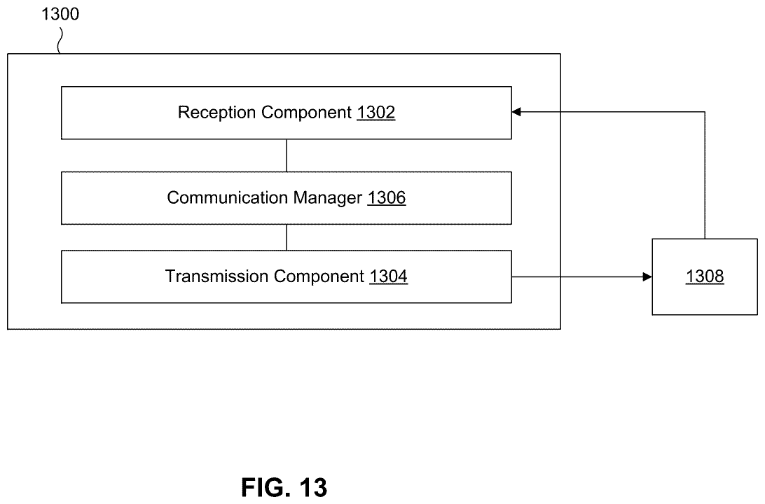

As shown in FIG. 11, in some aspects, process 1100 may include receiving, from an LTM candidate cell, a TDD pattern associated with the LTM candidate cell (block 1110). For example, the serving network node (e.g., using reception component 1302 and/or communication manager 1306, depicted in FIG. 13) may receive, from an LTM candidate cell, a TDD pattern associated with the LTM candidate cell, as described above.

As further shown in FIG. 11, in some aspects, process 1100 may include transmitting, to a UE, an LTM configuration that indicates the TDD pattern associated with the LTM candidate cell (block 1120). For example, the serving network node (e.g., using transmission component 1304 and/or communication manager 1306, depicted in FIG. 13) may transmit, to a UE, an LTM configuration that indicates the TDD pattern associated with the LTM candidate cell, as described above.

Process 1100 may include additional aspects, such as any single aspect or any combination of aspects described below and/or in connection with one or more other processes described elsewhere herein.

In a first aspect, the serving network node and the LTM candidate cell are associated with different CUs.

In a second aspect, alone or in combination with the first aspect, process 1100 includes sending a request for the TDD pattern to the LTM candidate cell through a backhaul link, wherein the TDD pattern is received from the LTM candidate cell in response to the request.

In a third aspect, alone or in combination with one or more of the first and second aspects, the TDD pattern associated with the LTM candidate cell is received with an RRC configuration associated with the LTM candidate cell.

In a fourth aspect, alone or in combination with one or more of the first through third aspects, the TDD pattern associated with the LTM candidate cell is received separately from an RRC configuration associated with the LTM candidate cell.

In a fifth aspect, alone or in combination with one or more of the first through fourth aspects, the TDD pattern associated with the LTM candidate cell is received during an LTM preparation stage.

In a sixth aspect, alone or in combination with one or more of the first through fifth aspects, the TDD pattern associated with the LTM candidate cell is included in an RRC configuration associated with the LTM candidate cell that is received during an LTM preparation stage.

In a seventh aspect, alone or in combination with one or more of the first through sixth aspects, the LTM configuration indicates the TDD pattern associated with the LTM candidate cell within an early uplink synchronization configuration associated with the LTM candidate cell.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication. The apparatus 1200 may be a UE 120, or a UE 120 may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE 120 or a network node 110 (such as a CU, a DU, an RU, or a base station), using the reception component 1202 and the transmission component 1204.

In some aspects, the apparatus 1200 may be configured to perform one or more operations described herein in connection with FIG. 9. Additionally, or alternatively, the apparatus 1200 may be configured to perform one or more processes described herein, such as process 1000 of FIG. 10. In some aspects, the apparatus 1200 and/or one or more components shown in FIG. 12 may include one or more components of the UE 120 described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE 120 described in connection with FIG. 1 and FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive an LTM configuration that indicates a TDD pattern associated with an LTM candidate cell. The communication manager 1206 may perform early uplink synchronization with the LTM candidate cell, wherein performing the early uplink synchronization includes identifying one or more valid reference signal occasions in the LTM candidate cell in accordance with the TDD pattern associated with the LTM candidate cell.

The reception component 1202 may receive, from a serving cell, a cell switch command triggering a handover from the serving cell to the LTM candidate cell. The communication manager 1206 may communicate with the LTM candidate cell in accordance with the TDD pattern indicated in the LTM configuration after the handover is complete.

The reception component 1202 may receive, from a serving cell, a cell switch command triggering a handover from the serving cell to the LTM candidate cell. The communication manager 1206 may communicate with the LTM candidate cell in accordance with the TDD pattern indicated in the RRC configuration or the system information associated with the LTM candidate cell after the handover is complete.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication. The apparatus 1300 may be a serving network node 110, or a serving network node 110 may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE 120 or a network node 110 (such as a CU, a DU, an RU, or a base station), using the reception component 1302 and the transmission component 1304.

In some aspects, the apparatus 1300 may be configured to perform one or more operations described herein in connection with FIG. 9. Additionally, or alternatively, the apparatus 1300 may be configured to perform one or more processes described herein, such as process 1100 of FIG. 11. In some aspects, the apparatus 1300 and/or one or more components shown in FIG. 13 may include one or more components of the network node 110 described in connection with FIG. 1 and FIG. 2. Additionally, or alternatively, one or more components shown in FIG. 13 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the serving network node described in connection with FIG. 1 and FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the serving network node described in connection with FIG. 1 and FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive, from an LTM candidate cell, a TDD pattern associated with the LTM candidate cell. The transmission component 1304 may transmit, to a UE, an LTM configuration that indicates the TDD pattern associated with the LTM candidate cell.

The communication manager 1306 may send a request for the TDD pattern to the LTM candidate cell through a backhaul link, wherein the TDD pattern is received from the LTM candidate cell in response to the request.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a UE, comprising: receiving an LTM configuration that indicates a TDD pattern associated with an LTM candidate cell; and identifying, in accordance with an early uplink synchronization with the LTM candidate cell, one or more valid reference signal occasions in the LTM candidate cell in accordance with the TDD pattern associated with the LTM candidate cell.

Aspect 2: The method of Aspect 1, wherein the LTM configuration indicates an RRC configuration associated with the LTM candidate cell separately from the TDD pattern associated with the LTM candidate cell.

Aspect 3: The method of any of Aspects 1-2, wherein the TDD pattern indicated in the LTM configuration is identical to a TDD pattern indicated in an RRC configuration or system information associated with the LTM candidate cell.

Aspect 4: The method of Aspect 3, further comprising: receiving, from a serving cell, a cell switch command triggering a handover from the serving cell to the LTM candidate cell; and communicating with the LTM candidate cell in accordance with the TDD pattern indicated in the LTM configuration after the handover is complete.

Aspect 5: The method of any of Aspects 1-4, wherein the TDD pattern indicated in the LTM configuration is different from a TDD pattern indicated in an RRC configuration or system information associated with the LTM candidate cell.

Aspect 6: The method of Aspect 5, further comprising: receiving, from a serving cell, a cell switch command triggering a handover from the serving cell to the LTM candidate cell; and communicating with the LTM candidate cell in accordance with the TDD pattern indicated in the RRC configuration or the system information associated with the LTM candidate cell after the handover is complete.

Aspect 7: The method of any of Aspects 1-6, wherein the LTM configuration indicates the TDD pattern associated with the LTM candidate cell at a same level as an early uplink synchronization configuration associated with the LTM candidate cell.

Aspect 8: The method of Aspect 7, further comprising: identifying, in accordance with the early uplink synchronization with the LTM candidate cell, one or more valid reference signal occasions in the LTM candidate cell in accordance with the TDD pattern associated with the LTM candidate cell.

Aspect 9: The method of any of Aspects 1-8, wherein the LTM configuration indicates the TDD pattern associated with the LTM candidate cell within an early uplink synchronization configuration associated with the LTM candidate cell.

Aspect 10: The method of any of Aspects 1-9, wherein the one or more valid ROs include one or more ROs that are within uplink symbols in a PRACH slot.

Aspect 11: The method of any of Aspects 1-10, wherein the one or more valid ROs include one or more ROs that do not precede an SSB in a PRACH slot and start at least a threshold number of symbols after a last downlink symbol and at least the threshold number of symbols after a last SSB symbol in the PRACH slot.

Aspect 12: A method of wireless communication performed by a serving network node, comprising: receiving, from an LTM candidate cell, a TDD pattern associated with the LTM candidate cell; and transmitting, to a UE, an LTM configuration that indicates the TDD pattern associated with the LTM candidate cell.

Aspect 13: The method of Aspect 12, wherein the serving network node and the LTM candidate cell are associated with different CUs.

Aspect 14: The method of any of Aspects 12-13, further comprising: sending a request for the TDD pattern to the LTM candidate cell through a backhaul link, wherein the TDD pattern is received from the LTM candidate cell in response to the request.

Aspect 15: The method of any of Aspects 12-14, wherein the TDD pattern associated with the LTM candidate cell is received with an RRC configuration associated with the LTM candidate cell.

Aspect 16: The method of any of Aspects 12-15, wherein the TDD pattern associated with the LTM candidate cell is received separately from an RRC configuration associated with the LTM candidate cell.

Aspect 16: The method of any of Aspects 12-16, wherein the TDD pattern associated with the LTM candidate cell is received during an LTM preparation stage.

Aspect 18: The method of any of Aspects 12-17, wherein the TDD pattern associated with the LTM candidate cell is included in an RRC configuration associated with the LTM candidate cell that is received during an LTM preparation stage.

Aspect 19: The method of any of Aspects 12-18, wherein the LTM configuration indicates the TDD pattern associated with the LTM candidate cell within an early uplink synchronization configuration associated with the LTM candidate cell.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a Layer 1 or Layer 2 (L1/L2) triggered mobility (LTM) configuration that indicates a time division duplexing (TDD) pattern associated with an LTM candidate cell; and
identify, in accordance with an early uplink synchronization with the LTM candidate cell, one or more valid random access channel (RACH) occasions (ROs) in the LTM candidate cell in accordance with the TDD pattern associated with the LTM candidate cell.

2. The UE of claim 1, wherein the LTM configuration indicates a radio resource control (RRC) configuration associated with the LTM candidate cell separately from the TDD pattern associated with the LTM candidate cell.

3. The UE of claim 1, wherein the TDD pattern indicated in the LTM configuration is identical to a TDD pattern indicated in a radio resource control (RRC) configuration or system information associated with the LTM candidate cell.

4. The UE of claim 3, wherein the one or more processors are further configured to cause the UE to:
receive, from a serving cell, a cell switch command triggering a handover from the serving cell to the LTM candidate cell; and
communicate with the LTM candidate cell in accordance with the TDD pattern indicated in the LTM configuration after the handover is complete.

5. The UE of claim 1, wherein the TDD pattern indicated in the LTM configuration is different from a TDD pattern indicated in a radio resource control (RRC) configuration or system information associated with the LTM candidate cell.

6. The UE of claim 5, wherein the one or more processors are further configured to cause the UE to:
receive, from a serving cell, a cell switch command triggering a handover from the serving cell to the LTM candidate cell; and
communicate with the LTM candidate cell in accordance with the TDD pattern indicated in the RRC configuration or the system information associated with the LTM candidate cell after the handover is complete.

7. The UE of claim 1, wherein the LTM configuration indicates the TDD pattern associated with the LTM candidate cell at a same level as an early uplink synchronization configuration associated with the LTM candidate cell.

8. The UE of claim 7, wherein the one or more processors are further configured to cause the UE to:
identify, in accordance with the early uplink synchronization with the LTM candidate cell, one or more valid reference signal occasions in the LTM candidate cell in accordance with the TDD pattern associated with the LTM candidate cell.

9. The UE of claim 1, wherein the LTM configuration indicates the TDD pattern associated with the LTM candidate cell within an early uplink synchronization configuration associated with the LTM candidate cell.

10. The UE of claim 1, wherein the one or more valid ROs include one or more ROs that are within uplink symbols in a physical RACH (PRACH) slot.

11. The UE of claim 1, wherein the one or more valid ROs include one or more ROs that do not precede a synchronization signal block (SSB) in a physical RACH (PRACH) slot and start at least a threshold number of symbols after a last downlink symbol and at least the threshold number of symbols after a last SSB symbol in the PRACH slot.

12. A serving network node for wireless communication, comprising:
one or more memories; and
one or more processors, coupled to the one or more memories, configured to cause the serving network node to:
receive, from a Layer 1 or Layer 2 (L1/L2) triggered mobility (LTM) candidate cell, a time division duplexing (TDD) pattern associated with the LTM candidate cell; and
transmit, to a user equipment (UE), an LTM configuration that indicates the TDD pattern associated with the LTM candidate cell.

13. The network node of claim 12, wherein the TDD pattern associated with the LTM candidate cell is received with a radio resource control (RRC) configuration associated with the LTM candidate cell.

14. The network node of claim 12, wherein the TDD pattern associated with the LTM candidate cell is received separately from a radio resource control (RRC) configuration associated with the LTM candidate cell.

15. The network node of claim 12, wherein the TDD pattern associated with the LTM candidate cell is received during an LTM preparation stage.

16. The network node of claim 12, wherein the LTM configuration indicates the TDD pattern associated with the LTM candidate cell within an early uplink synchronization configuration associated with the LTM candidate cell.

17. A method of wireless communication performed by a user equipment (UE), comprising:
receiving a Layer 1 or Layer 2 (L1/L2) triggered mobility (LTM) configuration that indicates a time division duplexing (TDD) pattern associated with an LTM candidate cell; and
identifying, in accordance with an early uplink synchronization with the LTM candidate cell, one or more valid random access channel (RACH) occasions (ROs) in the LTM candidate cell in accordance with the TDD pattern associated with the LTM candidate cell.

18. The method of claim 17, wherein the LTM configuration indicates the TDD pattern associated with the LTM candidate cell within an early uplink synchronization configuration associated with the LTM candidate cell.

19. The method of claim 17, wherein the one or more valid ROs include one or more ROs that are within uplink symbols in a physical RACH (PRACH) slot.

20. The method of claim 17, wherein the one or more valid ROs include one or more ROs that do not precede a synchronization signal block (SSB) in a physical RACH (PRACH) slot and start at least a threshold number of symbols after a last downlink symbol and at least the threshold number of symbols after a last SSB symbol in the PRACH slot.
